(19) United States
(12) Patent Application Publication
(10) Pub. No.: US 2016/0140147 A1
(43) Pub. Date: May 19, 2016

(54) Searching for a map using an input image as a search query

(71) Applicant: Vasan Sun, Bangkok (TH)

(72) Inventor: Vasan Sun, Bangkok (TH)

(21) Appl. No.: 14/772,688

(22) PCT Filed: Jun. 12, 2014
(86) PCT No.: PCT/TH2014/000026

§ 371 Date: Sep. 3, 2015

(51) Int. Cl. G06F 17/30

(52) U.S. Cl. CPC G06F 17/30277; G06F 17/30241; G06F 17/30259; G06F 17/30268

(57) ABSTRACT

Example embodiments relate generally to methods, systems, and devices for searching for a map using an image a search query. In an example embodiment, a method comprises performing an image recognition process to the input image and performing a character recognition process to the input image. The method further comprises performing a search query revision process to obtain a revised search query set. The method further comprises searching, in a map database, the searching comprising selecting one or more map images from among a plurality of map images in the map database. The method further comprises returning a resultant map image when the resultant map image is determined by the comparing to be a match.

### TECHNICAL FIELD

The present disclosure relates generally to methods, systems, devices, and computer-readable medium for use in searching for a map, and more specifically, searching for a map by using input images as a search query.

### BACKGROUND

Computer hardware companies continue to develop and roll out new and improved computing devices. Computing devices include non-portable computing devices, such as servers, desktop computers, all-in-one computers, and smart appliances, and portable computing devices, such as notebook/laptop computers, ultrabooks, tablets, phablets, readers, PDAs, mobile phones, mapping/GPS devices, wearable devices such as Galaxy Gear and Google Glass, and the like. Computer software developers also continue to develop and roll out new and improved products and services. Software products and services include software applications, mobile applications, widgets, websites, mobile websites, social networks, e-commerce, streaming services, location-related services such as GPS, mapping, and augmented reality, gaming, cloud computing, software as a service (SAAS), and the like.

With advances in computing devices and software products and services, users are becoming increasingly empowered to search for and access information, perform computing, socialize, and increase productivity.

### SUMMARY

Despite recent advances in computing devices and software products and services, including map-related software products and services, it is recognized in the present disclosure that difficulties and/or inabilities are oftentimes encountered when searching for and/or retrieving a map of a desired geographical location via a computing device.

Present example embodiments relate generally to methods, systems, devices, logic, and computer-readable medium for displaying a digital map.

In an exemplary embodiment, a method is disclosed for searching for a map. The method comprises receiving, as a search query, an input image. The method further comprises performing an image recognition process to the input image, the image recognition process operable to locate a non-textual feature rendered in the input image and derive a transformed representation of the non-textual feature rendered in the input image. The method further comprises performing a character recognition process to the input image, the character recognition process operable to locate a textual feature rendered in the input image and derive a textual representation of the textual feature rendered in the input image. The method further comprises performing a search query revision process to generate a revised search query set, the revised search query set comprising the transformed representation of the non-textual feature rendered in the input image and the textual representation of the textual feature rendered in the input image. The method further comprises searching, in a map database. The searching comprises comparing the revised search query set to a record set associated with one or more map images in the map database, each record set of each map image comprising a transformed representation of a geographical feature rendered in the map image and a textual representation of a geographical label in the map image. The method further comprises returning a resultant map image from among the one or more map images used in the comparing when the record set associated with the resultant map image is determined by the comparing to be a match to the revised search query set.

In another exemplary embodiment, a method is disclosed for searching for a map. The method comprises receiving, as a search query, an input image. The method further comprises deriving a transformed representation of a non-textual feature rendered in the input image. The method further comprises deriving a textual representation of a textual feature rendered in the input image. The method further comprises generating a revised search query, the revised search query comprising the transformed representation of the non-textual feature rendered in the input image and the textual representation of the textual feature rendered in the input image. The method further comprises searching, in a map database, the searching comprising comparing the revised search query to a non-textual feature and a textual feature rendered in one or more map images in the map database. The method further comprises returning a resultant map image when the resultant map image is determined by the searching to be a match to the revised search query.

In another exemplary embodiment, a system is disclosed for searching for a map. The system comprises a map database having one or more map images and a processor in communication with the map database. The processor is operable to receive, as the search query, an input image. The processor is further operable to perform a character recognition process to the input image, the character recognition process operable to locate a textual feature rendered in the input image and derive a textual representation of the textual feature rendered in the input image. The processor is further operable to perform an image recognition process to the input image, the image recognition process operable to locate a non-textual feature rendered in the input image and derive a transformed representation of the non-textual feature rendered in the input image. The processor is further operable to perform a search query revision process to generate a revised search query set, the revised search query set comprising the transformed representation of the non-textual feature rendered in the input image and the textual representation of the textual feature rendered in the input image. The processor is further operable to search, in the map database. The search comprises comparing the revised search query set to a record set associated with one or more map images in the map database, each record set of each map image comprising a transformed representation of a geographical feature rendered in the map image and a textual representation of a geographical label in the map image. The processor is further operable to return a resultant map image from among the one or more map images used in the comparing when the record set associated with the resultant map image is determined by the comparing to be a match to the revised search query set.

In another exemplary embodiment, a method is disclosed for configuring a system to perform a search for a map using an input image as a search query. The system comprises a map database and a processor. The method comprises configuring the map database. The configuring of the map database comprises locating a geographical feature rendered in a map image of the map database. The configuring of the map database further comprises deriving a transformed representation of the geographical feature. The configuring of the map database further comprises locating a geographical label in the map image associated with the geographical feature. The configuring of the map database further comprises creating a record set associated with the map image, the record set comprising the geographical label and the transformed representation of the geographical feature. The method further comprises configuring the processor, the processor in communication with the map database. The processor is configured to receive, as a search query, an input image. The processor is further configured to locate a non-textual feature rendered in the input image. The processor is further configured to derive a transformed representation of the non-textual feature rendered in the input image. The processor is further configured to locate a textual feature rendered in the input image. The processor is further configured to derive a textual representation of the textual feature rendered in the input image. The processor is further configured to generate a revised search query set, the revised search query set comprising the textual representation of the textual feature rendered in the input image and the transformed representation of the non-textual feature rendered in the input image. The processor is further configured to search the map database, the search comprising comparing the revised search query set to the record set and record sets associated with other map images in the map database. The processor is further configured to return a resultant map image from among the map image and the other map images when the record set associated with the resultant map image is determined by the search to be a match to the revised search query set.

In another exemplary embodiment, logic is disclosed for performing map searches. The logic is embodied in a non-transitory computer-readable medium and, when executed, operable to receive, as a search query, an input image; derive a transformed representation of a non-textual feature rendered in the input image; derive a textual representation of a textual feature rendered in the input image; generate a revised search query set, the revised search query set comprising the transformed representation of the non-textual feature rendered in the input image and the textual representation of the textual feature rendered in the input image; search, in a map database, the search comprising comparing the revised search query set to a record set associated with one or more map images in the map database, each record set of each map image comprising a transformed representation of a geographical feature rendered in the map image and a textual representation of a geographical label in the map image; and returning a resultant map image from among the one or more map images used in the comparing when the record set associated with the resultant map image is determined by the comparing to be a match to the revised search query set.

In another exemplary embodiment, a computing device is described for performing map searches. The computing device comprises a graphical display and a processor. The processor is in communication with the graphical display. The processor is operable to receive, as a search query, an input image; derive a textual representation of a textual feature rendered in the input image; derive a transformed representation of a non-textual feature rendered in the input image; perform a search query revision process to obtain a revised search query set, the revised search query set comprising the transformed representation of the non-textual feature rendered in the input image and the textual representation of the textual feature rendered in the input image; search, in a map database, the search comprising comparing the revised search query set to a record set associated with one or more map images in the map database, each record set of each map image comprising a transformed representation of a geographical feature rendered in the map image and a textual representation of a geographical label in the map image; and display a resultant map image on the graphical display, the resultant map image being selected from among the one or more map images used in the comparing when the record set associated with the resultant map image is determined by the comparing to be a match to the revised search query set.

In another exemplary embodiment, a method is described for performing map searches. The method comprises receiving, as a search query, an input image. The method further comprises deriving a revised search query set from the input image, the revised search query set comprising a representation of a non-textual feature rendered in the input image and a representation of a textual feature rendered in the input image. The method further comprises searching, in a map database, the searching comprising comparing the revised search query set to one or more portions of one or more map images in the map database. The method further comprises returning a resultant map image, the resultant map image comprising one or more portions of the one or more map images used in the comparing that best matches the revised search query.

### BRIEF DESCRIPTION OF THE DRAWINGS

For a more complete understanding of the present disclosure, example embodiments, and their advantages, reference is now made to the following description taken in conjunction with the accompanying drawings, in which like reference numbers indicate like features, and:

FIG. 1 is an example of an input image; and

FIG. 2 is an example embodiment of a system for searching for a map;

FIG. 3 is an example embodiment of a method for searching for a map;

FIG. 4 is an example embodiment of a method of receiving an input image as a search query;

FIG. 5A is an example embodiment of a method of deriving a revised search query set;

FIG. 5B is a conceptual depiction of an example embodiment of deriving a revised search query set from an input image;

FIG. 6A is a conceptual depiction of an example embodiment of a revised search query set;

FIG. 6B is a conceptual depiction of an example embodiment of another revised search query set;

FIG. 6C is a conceptual depiction of an example embodiment of another revised search query set;

FIG. 7A is an example embodiment of a method of preparing a map database for searching;

FIG. 7B is a conceptual depiction of an example embodiment of deriving a record set from a map image;

FIG. 8A is a conceptual depiction of an example embodiment of a record set;

FIG. 8B is a conceptual depiction of an example embodiment of another record set;

FIG. 8C is a conceptual depiction of an example embodiment of another record set;

FIG. 9 is a conceptual depiction of an example embodiment of deriving a revised search query set from an input image;

FIG. 10 is a conceptual depiction of an example embodiment of deriving a record set for a map image; and

FIG. 11 is a depiction of an example map image in the map database.

Although similar reference numbers may be used to refer to similar elements for convenience, it can be appreciated that each of the various example embodiments may be considered to be distinct variations.

Example embodiments will now be described with reference to the accompanying drawings, which form a part of the present disclosure, and which illustrate example embodiments which may be practiced. As used in the present disclosure and the appended claims, the terms “example embodiment,” “exemplary embodiment,” and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on,” and the terms “a,” “an” and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon,” depending on the context. Furthermore, as used in the present disclosure and the appended claims, the words “and/or” may refer to and encompass any and all possible combinations of one or more of the associated listed items. Furthermore, as used herein, the words “and/or” may refer to and encompass any and all possible combinations of one or more of the associated listed items.

### DETAILED DESCRIPTION

With recent advances in computing devices and computer software products and services, users are becoming increasingly empowered to search for and access information, perform computing, socialize, and increase productivity.

For example, search engines, and the like, have enabled users to perform text-based searches to find and access information from websites and/or databases. As used herein, text-based searches are searches performed by entering, into one or more text fields, a search query of one or more characters or words (“textual search query”) and submitting the textual search query to a search engine. Once a textual search query is received, search engines apply specific methods and procedures (algorithms) to search for and return information that is/are determined to be a closest match to the textual search query. Examples of search engines include those offered by Google, Yahoo, Microsoft, Amazon, Ebay, Baidu, Yandex, Facebook, Wikipedia, and CNet; online real estate services such as Zillow, MLS.ca, realestate.com, and DDproperty; map websites and applications such as Google Maps, Apple Maps, and MapQuest; and travel websites and services such as Expedia, TripAdvisor, and hotels.com.

Several search engines also enable users to search for and access images, videos, and/or audio via text-based searches. Once a textual search query is received, search engines compare one or more aspects of the textual search query with text labels, metadata, and/or text associated with and/or in close proximity to images, videos, and/or audio. For example, a found image (or link to a found image) may be one in which a file name of the image, metadata of the image, and/or text nearby to the image is determined to be a closest match to the textual search query. The found image may then be returned to the user by the search engine as a search result. Examples of image and/or video search engines include Google's image and video search, Yahoo's image and video search, YouTube, Pandora, iTunes, App Store, Play Store, and Pinterest.

As another example, software developers have developed specialized software products and services operable to perform character recognition, that is, extracting text from images. For example, Adobe Reader and some other software products and services provide for character recognition features that enable a user to extract text in English and/or other languages from portions, sections, or areas (“portions”) of an image when such portions are determined to include textual content. Advantages of such features include allowing a user to extract, interact, manipulate, listen to, and/or translate the textual content, and/or without requiring the user to re-type the textual content rendered in the image.

Software developers have also developed specialized software products and services operable to perform image recognition. Such software products and/or services enable a user to identify, extract, analyze, and/or compare one or more portions of an image based on shapes and/or other features contained in the image. Examples of such specialized software products and services include facial recognition software, red-eye detection/correction software for digital images, Adobe Photoshop and other Adobe products, and the Samsung S Note application. As a simple example, an image recognition procedure may be operable to identify and locate shapes within a digital image, such as lines, triangles, squares, rectangles, circles, etc.

In yet another example, with the introduction of map-related software products and services for searching and providing maps, consumers have become more enabled to more readily access and search for maps, specific locations in maps, directions (such as driving routes, walking routes, public transportation routes, alternative routes, etc., hereinafter “routes”), and information (such as related websites, user ratings, user comments, etc.). As used in the present disclosure, the term “maps” or “geographical maps” includes any type of map, including normal maps, geographical maps, satellite maps, maps having layers or overlays of additional information (such as traffic, information, geographical labels (textual information in maps), etc.), and maps will include geographical features (such as streets, landmarks, etc.) and geographical labels (such as street names, landmark names, etc.). To perform a search for a map, a user is required to enter a textual search query into one or more text fields. The textual search query may include an address, a part of an address, a name of an organization or business, or latitude/longitude information. Examples of map products and applications include Google Maps, GMaps+, Apple Maps, MapQuest, Yahoo Maps, Bing Maps, OpenStreetMap.org, Crowdmap, Ask Maps, SkyMap, HERE Maps, Waze, Scout, and those offered by Magellan, Garmin, Navigon, and TomTom.

U.S. Pat. No. 7,894,984 to Rasmussen et al. (“Rasmussen”), herein incorporated by reference in its entirety, describes several ways of implementing a digital mapping system for use in searching for a map using textual input as a textual search query. For example, Rasmussen describes a method in which a user via a web browser enters a series of text representing a desired location, such as an address, into one or more text fields and transmits the location information to a web server. The web server then transmits a database query containing the requested location data to a map raster database, which extracts an appropriate part of a larger pre-rendered map image based on the database query. The appropriate map image is then transmitted to the user's web browser. Rasmussen also discloses another approach directed to providing a location query text entry field for a user to enter a series of text representing a desired location, sending a location request with the desired location to a map tile server, receiving a set of map tiles in response to the location request, assembling the received map tiles into a tile grid, aligning the tile grid relative to a clipping shape, and displaying the result as a map image.

Despite recent advances in map-related software products and services, it is recognized in the present disclosure that users oftentimes encounter difficulties and/or inabilities in searching for and retrieving a desired map via a computing device.

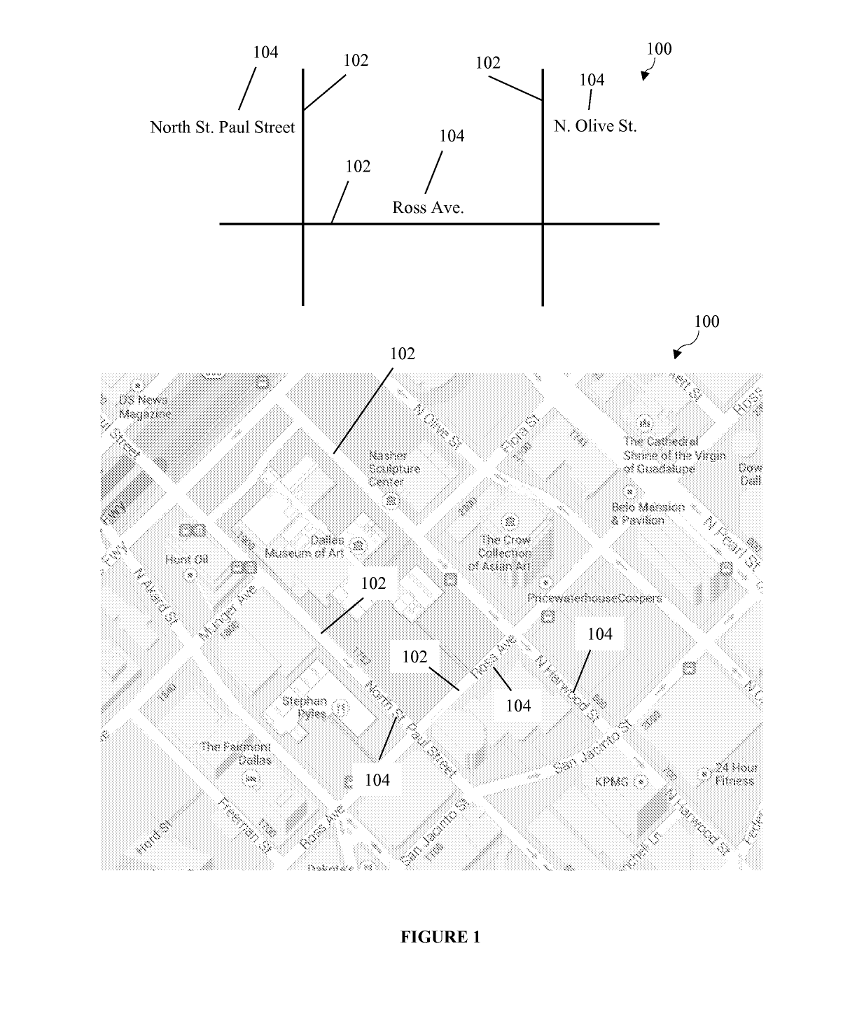

In an example situation, a user may be provided with a map on a physical medium (such as a piece of paper) and/or a map in the form of a digital image. The map may be any one of a hand-drawn map, computer-assisted drawing of a map (such as one drawn by a software application like Microsoft Word, Microsoft Paint, Adobe Photoshop, S Note available on the Samsung Note family, etc.), exact map (such as a print-out of a map from an online map service, an image of a map, a screen-capture of a map rendered on a map application, a photograph of a map, a conventional map book, and the like), map on an advertisement/brochure/website/etc., and the like (hereinafter “input map” or “input image”). The user may desire to display the input image on his/her computing device, such as in situations where the user wishes to see more details (such as nearby streets), get directions, possible routes, and traffic conditions, and see street views of the area (such as via Google's Street View). FIG. 1 illustrates examples of input images having more than one textual features in the form of street names and more than one non-textual features in the form of lines representing streets. In such examples, a user may attempt to perform a text-based search via a computing device for a desired map that best matches the input image. The user may do so by manually (visually) identifying one or more street names (textual features) rendered on the input image, making a decision regarding which of the one or more street names to use as a textual search query, launching a map application or online map service on the user's computing device, manually typing a street name in a text field of the map application or online service, and submitting the textual search query. When the map application and/or online service finds one or more map images that best matches the submitted textual search query, the one or more best matches (or links to the one or more best matches) may be downloaded and/or displayed on the user's computing device. Oftentimes, however, the results of a search based on a street name will return several map images, most of which will not be relevant to the user. The user may then be required to review the returned results, perform a series of additional text-based searches, and/or use navigation controls (including zooming in and/or out and panning in one or more directions) to manually (visually) search for and locate a match of other geographical features and/or geographical labels on the returned map image that best matches the non-textual features and/or the textual features rendered on the input image. In summary, when a user is provided with an input image, conventional methods will require the user to perform several steps and searches and waste a significant amount of time to attempt to arrive at a map that may or may not be a match to the input image.

Example embodiments of systems, devices, methods, logic, and computer-readable medium for searching for a map using an input image as a search query will now be described with reference to the accompanying drawings.

### Example Embodiments of an Input Image as a Search Query

The input image 100 may comprise one or more non-textual portions (or areas or sections) 102 having exact or inexact drawings resembling geometric shapes (lines, curves, circles, squares, rectangles, etc.) intended to represent one or more non-textual geographical features normally found in or associated with maps (hereinafter “non-textual features” or “geographical features”). Non-textual features 102 may include exact or inexact representations of streets (which is to be understood herein to include all forms and types of vehicular and pedestrian roadways and walkways, including roads, avenues, boulevards, crescents, streets, highways, freeways, toll ways, trails, paths, etc.), intersections, final destinations, buildings or other structures, rivers or other bodies of water, railways, landmarks, areas, and any other geographical features normally found in or associated with maps.

The input image 100 may also comprise one or more textual portions 104 having a series of characters or text in one or more languages representing one or more textual labels normally associated with (such as a name of) one or more geographical features (hereinafter “textual features” or “geographical labels”). Textual features may include exact or inexact textual representations of street names, intersection names, addresses, building or other structure names, names of rivers or other bodies of water, railways, other landmark names, and any other textual representation, or parts thereof, normally found in maps. For example, a non-textual feature in an input image depicted as a line (or parallel, perpendicular, and/or connected lines; dotted, dashed, or broken lines; curved lines; etc.) may represent one or more streets and may be associated with one or more textual features representing the name of the one or more streets.

### Example Embodiments of a System for Searching for a Map

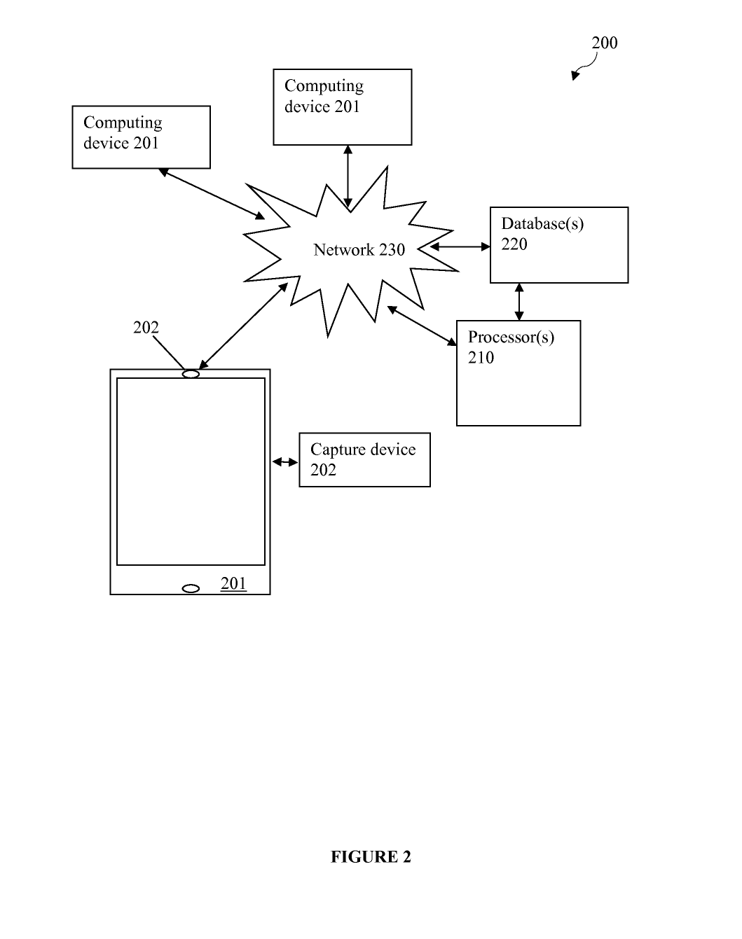

An example embodiment of a system 200 is illustrated in FIG. 2. The system 200 may comprise or be in communication with one or more computing devices 201, one or more processors (or servers) 210, one or more map databases 220, and network 230.

Example embodiments of the computing device 201 may comprise internal processor(s) (not shown, which may be operable to communicate with processors (or servers) 210 and map databases 220 via network 230) and memory (not shown), and the computing device 201 may be operable to launch (on a graphical display, not shown) and access an example embodiment of a map application and/or online map service via network 230. The computing device 201 may also be operable to store information, including input images and map images. The computing device 201 may also be operable to communicate with and receive/transmit information (such as input images and map images) from/to example embodiments of processor 210 and/or map database 220, other processors (not shown), the Internet, and/or other networks. The computing device 201 may also be operable to capture digital images, including input images, via an image capturing device (such as a camera or wearable computing device) 202 integrated in and/or associated with the computing device 201.

The processor 210 may be operable to communicate with and receive/transmit information (such as input images and map images) from/to the computing device 201, the map database 220, other processors (not shown), the Internet, network 230, and/or other networks. The processor 210 may also be operable to perform an image recognition process (as explained below and herein), perform a character recognition process (as explained below and herein), derive a revised search query (as explained below and herein), prepare a map database for searching (as explained below and herein), search a map database (as explained below and herein), and/or return a resultant map image (as explained below and herein). It is to be understood in the present disclosure that the computing device 201 may be operable to perform some, most, or all of the operations of the processor 210 (such as the example methods and processes described above and herein) in example embodiments without departing from the teachings of the present disclosure. It is also to be understood in the present disclosure that some, most, or all of the operations of the processor 210 may be performable by a plurality of processors 210, such as via cloud computing, in example embodiments without departing from the teachings of the present disclosure.

The map database 220 may comprise one or more map images (such as one or more large images, several smaller image tiles, and/or map images generated on demand), and each of the one or more map images may comprise one or more geographical features, one or more geographical labels, and/or other information normally found in maps. The map database 220 may also comprise one or more record sets (as explained below and herein) associated with each map image, each record set comprising one or more textual representations of geographical labels (as explained below and herein), one or more transformed representations of geographical features (as explained below and herein), one or more associations (as explained below and herein), one or more relationships (as explained below and herein), and/or one or more classifications (as explained below and herein). The one or more map images in the map database 220 may cover the same, similar, or different sized geographical areas, such as most of or an entire world, a hemisphere, a continent, an area (such as between certain latitudes/longitudes), a country, a section of a country or territory such as a state or province, a city, a district, a prefecture, a zip or postal code, or geometrical-shaped area. The one or more map images in the map database 220 may also be map tiles, or the like, that may be assembled together at the computing device 201 and/or the processor 210 to form one or more larger map images (the resultant map image) for downloading, viewing, and/or manipulating by the user.

### Example Embodiments of a Method for Searching for a Map

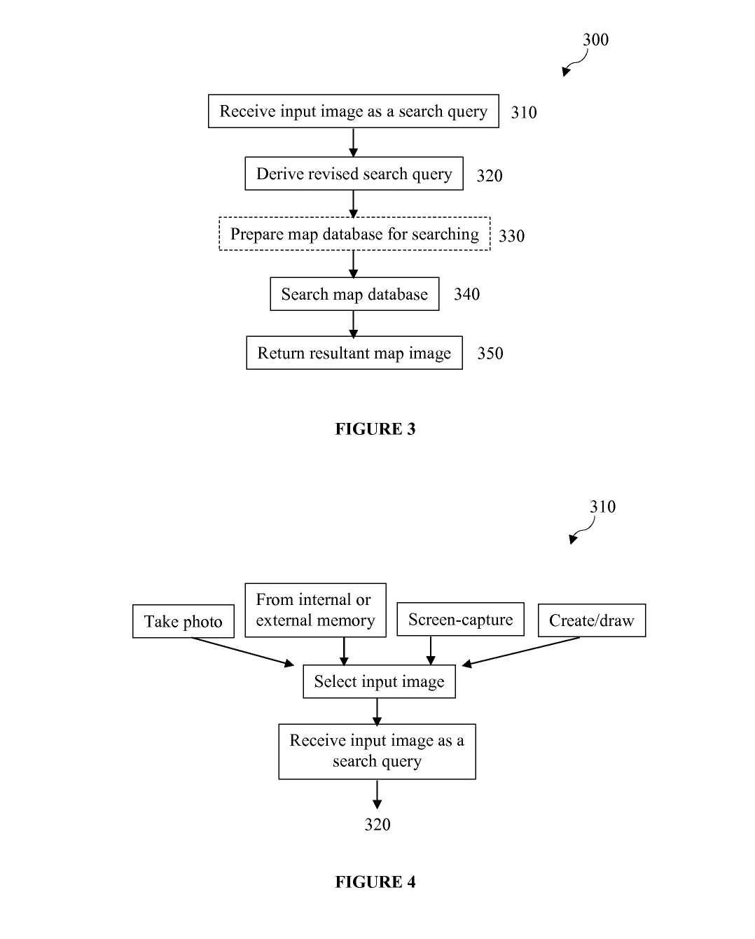

Referring now to FIG. 3, an example embodiment of a method may comprise one or more of the following actions: receiving the input image as a search query (e.g., action 310), deriving a revised search query (e.g., action 320), preparing a map database for searching (e.g., action 330), searching a map database comprising one or more map images (e.g., action 340), and/or returning a resultant map image (e.g., action 350). These actions will now be described with reference to FIGS. 3-11.

### (i) Receive an Input Image as a Search Query (e.g., Action 310)

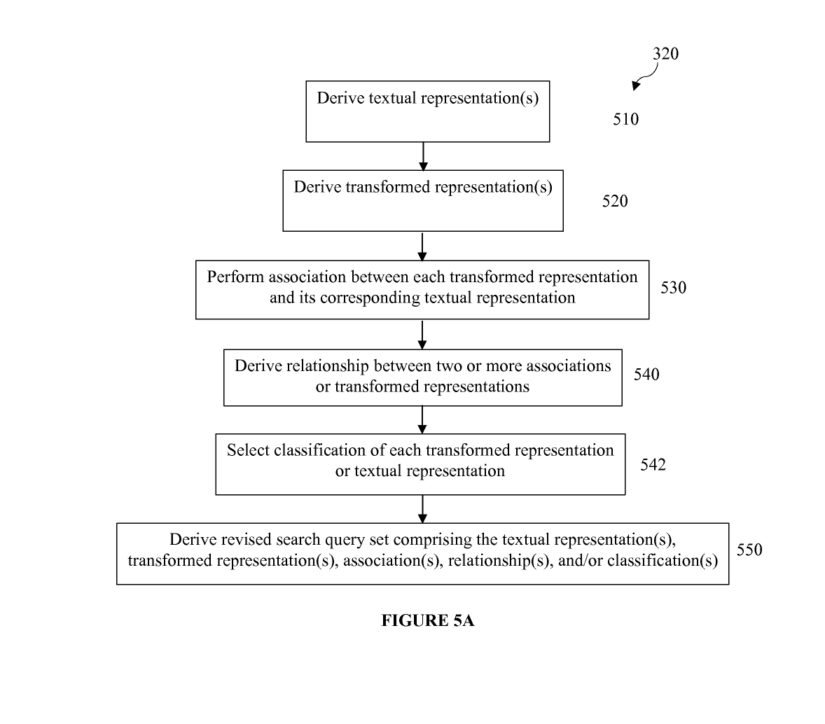

As illustrated in FIG. 4, the input image may be received (e.g., action 310) in one or more of a plurality of ways, including capturing the input image as a digital image using a camera 202 integrated in or associated with the computing device 201, selecting the input image from internal memory of or other memory associated with the computing device 201, performing a screen capture of an image displayed on the computing device 201, drawing the input image using an application on the computing device 201, and/or downloading the input image to the computing device 201 from an external source, such as a website, email, instant message, or the cloud. The input image may be a digital image, such as a digital photo. For example, a user of a computing device 201 may receive a piece of paper having drawn or printed on it a map, and the user may wish to perform a search for a map based on the map drawn on the piece of paper. As another example, a user of a computing device 201 may have an image of a map, such as a computer-assisted drawing of a map (drawn by a drawing application), a screen-capture of a map rendered by a map application or online map service, and/or those often found in advertisements for or websites of a retail store, a restaurant, a shopping mall, other types of businesses, etc. The computing device 201 may be operable to allow the user to manually draw, such as by using a stylus, mouse, and/or the users' finger on a touch screen of the computing device 201, the input image. For example, the computing device 201 may enable the user to draw the input image (and/or type and write textual features in the input image) using an application, such as the S Note application for the Samsung Note family, a drawing application, or the like. Such applications may also be operable to re-draw, derive, and/or amend non-exact geometrical shapes drawn by the user (and hand-written text written by the user) into more exact geometrical shapes (and computer readable text). An example of such an application is the Samsung S Note application, which allows users to convert non-straight lines into straight lines, non-square shapes into square shapes, non-rectangular shapes into rectangular shapes, non-circular shapes into circular shapes, etc. The input image may be stored in a database associated and/or in communication with the computing device 201 and/or the processor 210 before, at the same time as, or after being received (e.g., action 310).

Example embodiments of the computing device 201 may be operable to access example embodiments of a map application (such application may be stored as logic on a computer-readable medium of the computing device 201) and/or an online map service provided by processor 210, other processors (not shown), and/or map database 220, and provide (e.g., action 310) the input image as a search query.

The computing device 201, processor 210, and/or map database 220 may be operable to communicate with each other via wired and/or wireless communication, and such communication may be via network 230. In operation, the processor 210 and/or the computing device 201 may be operable to receive, as the search query, the input image via network 230.

### (ii) Derive a Revised Search Query (e.g., Action 320).

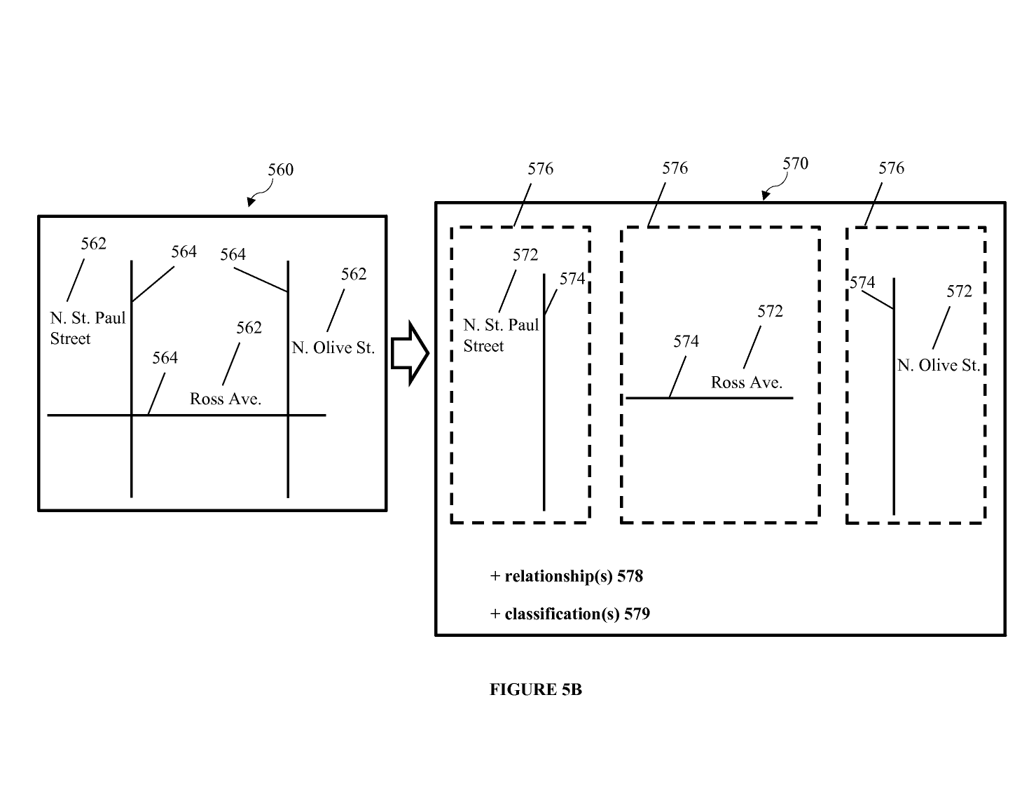

As illustrated in FIGS. 5A and 5B and FIG. 3, upon receiving (e.g., action 310) the input image 560 as a search query, example embodiments may be operable to perform a search query revision process so as to derive (e.g., actions 320, 550) a revised search query set (“revised search query set” or “revised search query”). For illustration purposes, an example revised search query set is conceptually illustrated as 570. The revised search query set 570 may comprise, among other things, one or more of non-textual feature(s) 564 rendered in the input image 560, textual feature(s) rendered in the input image 560, transformed representation(s) 574 of non-textual feature(s) 564 rendered in the input image 560 (including textual, non-textual, and/or other representation(s) 574 of non-textual feature(s) rendered in the input image 560), textual representation(s) 572 of textual feature(s) 562 rendered in the input image 560, association(s) 576, relationship(2) 578, and/or classification(s) 579, as further described below and herein.

In the deriving (e.g., actions 320, 550) of a revised search query set 570, example embodiments may derive (e.g., action 510) textual representation(s) 572 of textual feature(s) 562 rendered in the input image 560. Example embodiments of such deriving (e.g., action 510) may include performing a character recognition process to the input image 560. It is to be understood in the present disclosure that any one or more character recognition processes may be applied to the input image 560 without departing from the teachings of the present disclosure, and that the character recognition process may include handwriting recognition. The character recognition process may be operable to first locate textual feature(s) 562, such as a street name and/or name of a landmark, rendered in the input image 560. In example embodiments, the character recognition process may also be operable to locate textual feature(s) nearby, outside of, and/or associated with (such as metadata) the input image 560. Once the textual feature(s) 562 rendered in the input image 560 is/are located, example embodiments may be operable to derive (e.g., action 510) textual representation(s) 572 for each textual feature 562. It is to be understood in the present disclosure that the textual features 562 and/or the textual representations 572 of the textual features 562 may be in the English language and/or in any other language, and language translations may also be performable before, during, or after the deriving (e.g., action 520). It is also to be understood in the present disclosure that textual feature(s) 562 may include partial or complete addresses.

In the deriving (e.g., actions 320, 550) of a revised search query set 570, example embodiments may also derive (e.g., action 520) transformed representation(s) 574 of non-textual feature(s) 564 rendered in the input image 560. Example embodiments of such deriving (e.g., action 520) may include performing an image recognition process to the input image 560 before, during, and/or after the performing of the character recognition process (e.g., action 510). It is to be understood in the present disclosure that any one or more image recognition processes may be applied to the input image 560 without departing from the teachings of the present disclosure. The image recognition process may be operable to first locate non-textual feature(s) 564, such as drawings representing geographical features, rendered in the input image 560. Once the non-textual feature(s) 564 is/are located, example embodiments may be operable to derive (e.g., action 520) transformed representation(s) 574 for each non-textual feature 564.

The transformed representation(s) 574 of the non-textual feature(s) 564 rendered in the input image 560 may be any representation of the non-textual feature(s) 564, including a normalized or standardized representation, simplified representation, idealized representation, and the like. For example, when the non-textual feature 564 includes a hand-drawn or computer-assisted drawing of a line (such as a straight, dashed, and/or curved line) representing one or more streets that is/are not exactly straight (and/or exactly curved, etc.), the derived transformed representations 574 may be a straight or more straight line (and/or curved or more curved line, etc.). As another example, when the non-textual feature 564 includes a computer-assisted drawing of a square (or other geometric shapes) representing a city block or landmark that is not exactly square, the derived transformed representation 574 may be a more square or exactly square. As another example, when the non-textual feature 564 includes a hand-drawn circle representing a round-about that is not exactly circular, the derived transformed representation 574 may be an exact circle.

In example embodiments, the transformed representation(s) 574 of the non-textual feature(s) 564 may be rendered using one or more geometric shapes. That is, in the deriving (e.g., action 520) of the transformed representation(s) 574 of the non-textual feature(s) 564, one or more geometric shapes may be selected to form the transformed representation(s) 574 based on a closest match of the non-textual feature(s) 564 rendered in the input image 560 to geometric shape(s) in a list of available geometric shapes. The geometric shapes in the list of available geometric shapes may include a line (straight and/or curved), a square, rectangle, circle, ellipse, triangle, and/or other basic shapes, and combinations thereof.

In the deriving (e.g., actions 320, 550) of a revised search query set 570, example embodiments may also perform (e.g., action 530) an association (or pairing) 576 between a transformed representation 574 (and/or the non-textual feature 564 rendered in the input image 560, such as a street) and a textual representation 572 (and/or the textual feature 562 rendered in the input image 560, such as a street name) found to correspond to the transformed representation 574.

In the deriving (e.g., actions 320, 550) of a revised search query set 570, example embodiments may also derive (e.g., action 540) a relationship 578 between two or more associations 576, between two or more transformed representations 574, and/or between two or more non-textual features 574 rendered in the input image 560. In example embodiments, the relationship 578 may be selected based on a closest match of the relationship (between the two or more associations, between the two or more transformed representations, and/or between the two or more non-textual features) to a relationship in a list of available relationships. The relationships in the list of available relationships may include those pertaining to relative orientation (such as parallel, perpendicular, 45 degrees, etc.), relative order (such as one association is to the left of another association, one association is above another association, one association is 45 degrees north-east of another association, etc.), relative size (one city block is smaller than another city block, etc.), and/or other describable and distinguishable relationships.

In the deriving (e.g., actions 320, 550) of a revised search query set 570, example embodiments may also select (e.g., action 542) a classification 579 for the association 576, the relationship 578, the transformed representation 574, and/or the textual representation 572 from among a list of classifications. The list of classifications may include one or more man-made geographical features and/or one or more naturally-occurring geographical features. For example, geographical features in the list of classifications may include a street (or type of street, such as an avenue, street, road, crescent, circle, highway, freeway, toll way, etc.), an intersection (such as a 3-way intersection, 4-way intersection, 5-way intersection, intersection between a street and a railway, etc.), bridge (such as a pedestrian bridge, vehicular bridge, etc.), tunnel, railway, pedestrian walkway, waterway (such as a stream, river, channel, etc.), landmark (such as a building, monument, business, park, etc.), and the like.

Accordingly, each revised search query set 570 for input image 560 may comprise one or more textual features 562, one or more non-textual features 564, one or more textual representations 572, one or more transformed representations 574, one or more associations (or pairings) 576, one or more relationships 578, and/or one or more classifications 579. In example embodiments, the revised search query set 570 may also include other information, such as the location of the computing device 202, user-specific information (such as history of previous searches, saved searches, etc.) and/or user login information for accessing such, and other information obtainable from the computing device 202 and/or processor 210.

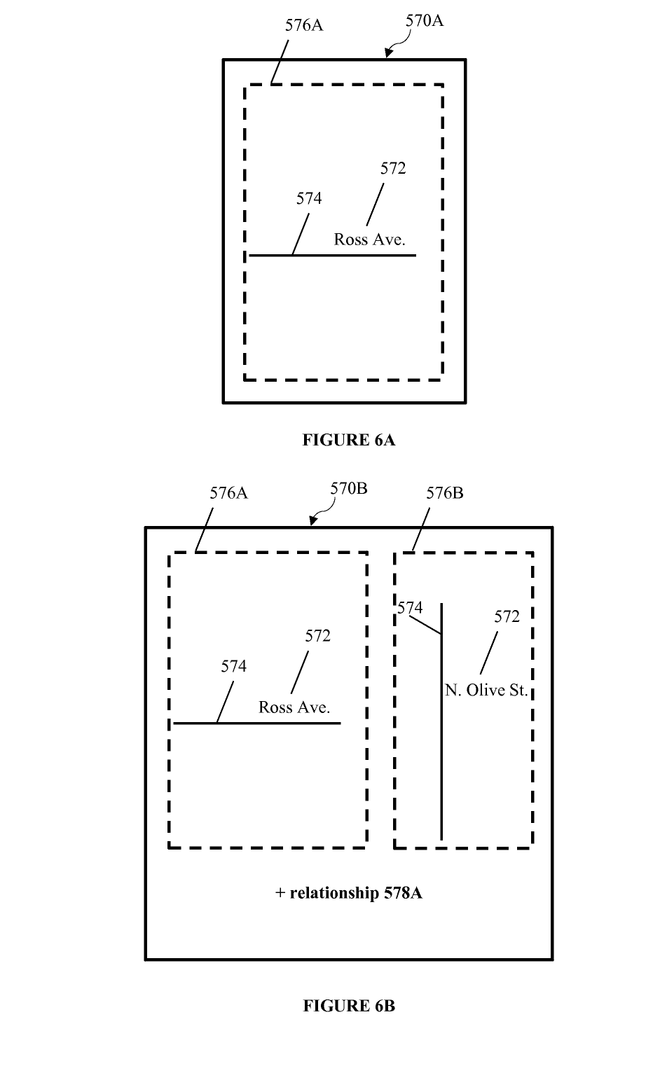

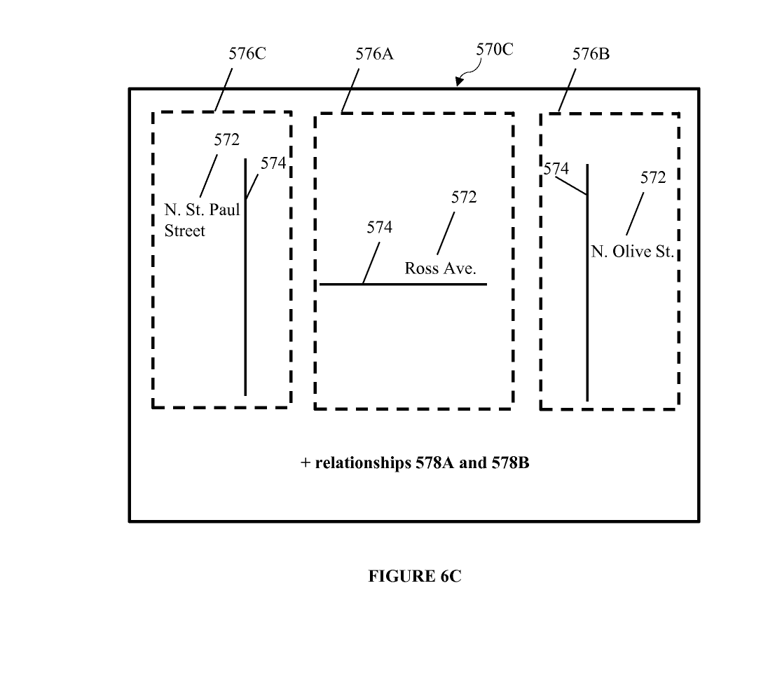

It is recognized in the present disclosure that a revised search query set 570 comprising a greater number of associations 576 and/or relationships 578 between associations 576 may enable example embodiments to more quickly and/or accurately search for and return a resultant map. For example, as conceptually illustrated in FIG. 6A, a revised search query set 570A having only one association 576A (a transformed representation of a street and its corresponding textual representation of “Ross Ave”) may return several resultant maps that match such a revised search query set. However, as conceptually illustrated in FIG. 6B, a revised search query set 570B having a first association 576A (a first transformed representation of a first street and its corresponding first textual representation of “Ross Ave”), a second association 576B (a second transformed representation of a second street and its corresponding second textual representation of “Olive St”), and a relationship 578A between the first association/transformed representation and the second association/transformed representation (substantially perpendicular to each other) may return far fewer resultant maps that match such a revised search query set (as compared to the example embodiment in FIG. 6A). As another example, as conceptually illustrated in FIG. 6C, a revised search query set 570C having a first association 576A (a first transformed representation of a first street and its corresponding first textual representation of “Ross Ave”), a second association 576B (a second transformed representation of a second street and its corresponding second textual representation of “Olive St”), a third association 576C (a third transformed representation of a third street and its corresponding third textual representation of “St. Paul Street”), a first relationship 578A between the first association/transformed representation and the second association/transformed representation (substantially perpendicular to each other), a second relationship 578B between the first association/transformed representation and the third association/transformed representation (substantially perpendicular to each other), and a third relationship 578C between the second association/transformed representation and the third association/transformed representation (substantially parallel to each other) may return even fewer resultant maps that match such a revised search query set (as compared to the example embodiments in FIGS. 6A and 6B). It is to be understood in the present disclosure that a relationship 578 between associations/transformed representation 576 may be between more than two associations/transformed representation, and such relationship need not be limited to relative orientation-related relationships. For example, a relationship may include a relative order (such as from left to right, top to bottom, east to west, south to north, 45 degrees north-east, etc.), relative size, intersections (such as the first association intersects with the second association and the third association), continuations (such as when a road changes), and/or other relationships.

### (iii) Prepare a Map Database for Searching (e.g., Action 330).

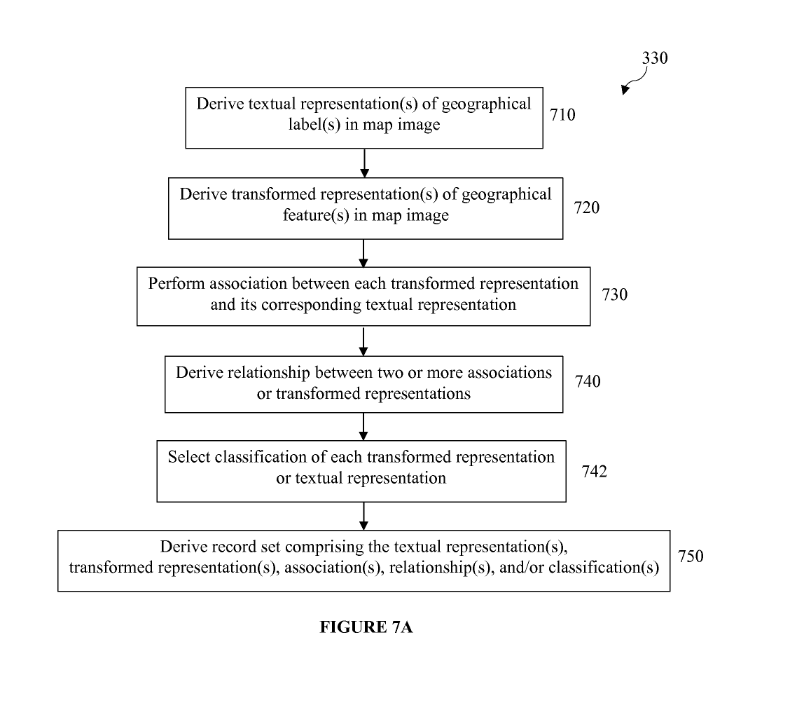

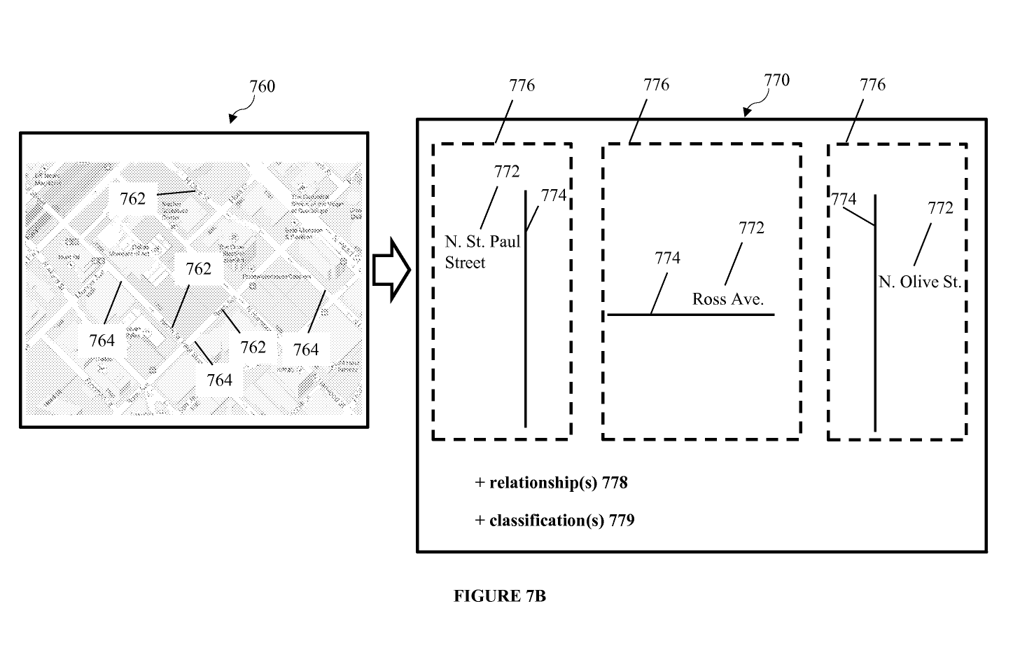

As illustrated in FIGS. 7A and 7B, example embodiments may be operable to derive (e.g., action 750) a record set 770 for one or more map images 760 in the map database 220. The record set 770 may comprise, among other things, geographical feature(s) 764 rendered in the input image 760, geographical label(s) 762 rendered in the input image 760, transformed representation(s) 774 of geographical feature(s) 764 rendered in the map image 760 (including textual, non-textual, and/or other representation(s) 574 of non-textual feature(s) rendered in the input image 560), textual representation(s) 772 of geographical label(s) 762 rendered in the map image 760, association(s) 776, relationship(s) 778, and/or classification(s) 779, as further described below and herein.

In the deriving (e.g., action 750) of a record set 770 for a map image 760, example embodiments may derive (e.g., action 710) textual representation(s) 772 of geographical label(s) 762 rendered in or associated with the map image 760. Example embodiments of such deriving (e.g., action 710) may include performing a character recognition process to the map image 760 (and/or data associated with the map images). Such deriving (e.g., action 710) may be performed in example embodiments during setting up and/or configuring of the map database 220, routinely, scheduled or unscheduled, periodically, upon demand, and/or as required. Alternatively or in addition, such deriving (e.g., action 710) may be performed upon receiving (e.g., action 310) each input image 560 as a search query. In example embodiments, the geographical label(s) 762 in a map image 760 may be used in performing the search (e.g., action 340) in addition to or without performing such character recognition process (i.e. without obtaining a textual representation 772). In such embodiments, the geographical label(s) 762 may be readily available to form a part of the record set 770 for the map image 760 and/or may be used directly in the search (e.g., action 340).

Example embodiments may be operable to perform a similar or substantially the same character recognition process (e.g., action 510) to the input image 560 as the character recognition process (e.g., action 710) performed for the map images 760 in the map database 220. In this regard, the use of a similar or substantially the same character recognition process in the deriving (e.g., action 510) of a textual representation 572 of a textual feature 562 rendered in an input image 510 and in the deriving (e.g., action 710) of a textual representation 772 of a geographical label 762 in the map image 760 may enable example embodiments to somewhat standardize the textual representations 572, 772 of the input image 560 and the map images 760, and therefore may allow example embodiments to perform more consistent and/or accurate searches and comparisons (e.g., action 340) of the input image 560 with the one or more map images 760 in the map database 220.

In the deriving (e.g., action 750) of a record set 770 for a map image 760, example embodiments may derive (e.g., action 720) transformed representation(s) 774 of geographical feature(s) 764 rendered in the map image 760. Example embodiments of such deriving (e.g., action 720) may include performing an image recognition process to the map image 760. Such deriving (e.g., action 720) may be performed in example embodiments during setting up and/or configuring of the map database 220, routinely, scheduled or unscheduled, periodically, upon demand, and/or as required. Alternatively or in addition, such deriving (e.g., action 720) may be performed upon receiving (e.g., action 310) each input image 560 as a search query. In example embodiments, the geographical feature(s) 764 in a map image 760 may be used in performing the search (e.g., action 340) in addition to or without performing such image recognition process (i.e. without obtaining a transformed representation 774). In such embodiments, the geographical feature(s) 764 may be readily available to form a part of the record set 770 for the map image 760 and/or may be used directly in the search (e.g., action 340).

Example embodiments may be operable to perform a similar or substantially the same image recognition process (e.g., action 520) to the input image 560 as the image recognition process (e.g., action 720) performed for the map images 760 in the map database 220. In this regard, the use of a similar or substantially the same image recognition process in the deriving (e.g., action 520) of a transformed representation 574 of a non-textual feature 564 rendered in an input image 510 and in the deriving (e.g., action 720) of a transformed representation 774 of a geographical feature 764 in the map image 760 may enable example embodiments to somewhat standardize the transformed representations 574, 774 of the input image 560 and the map images 760, and therefore may allow example embodiments to perform more consistent and/or accurate searches and comparisons (e.g., action 340) of the input image 560 with the one or more map images 760 in the map database 220.

In example embodiments, the transformed representation(s) 774 of the geographical feature(s) 764 may be rendered using one or more geometric shapes. That is, in the deriving (e.g., actin 720) of the transformed representation(s) 774 of the geographical feature(s) 764, one or more geometric shapes may be selected to form the transformed representation(s) 774 based on a closest match of the geographical feature(s) 764 to geometric shape(s) in a list of available geometric shapes. The geometric shapes in the list of available geometric shapes may include a line (straight and/or curved), a square, rectangle, circle, ellipse, triangle, and/or other basic shapes, and combinations thereof. In example embodiments, the transformed representation(s) 574 of the non-textual feature(s) 564 rendered in the input image 560 and the transformed representation(s) 774 of the geographical feature(s) 764 rendered in the map image 760 may be derived using similar or substantially the same geometric shapes and/or lists of available geometric shapes.

In the deriving (e.g., action 750) of a record set 770 for a map image 760, example embodiments may also perform (e.g., action 730) an association 776 between a transformed representation 774 of the geographical feature 764 rendered in the map image 760 and a textual representation 772 of the geographical label 762 in the map image 760 found to correspond to the transformed representation 774. Alternatively or in addition, example embodiments may perform (e.g., action 730) an association 776 between the geographical feature 764 rendered in the map image 760 and the geographical label 762 in the map image 760 found to correspond to the geographical feature 764.

In the deriving (e.g., action 750) of a record set 770 for a map image 760, example embodiments may also derive (e.g., action 740) a relationship 778 between two or more associations 776 or between two or more transformed representations 774. Alternatively or in addition, example embodiments may derive (e.g., action 740) a relationship 778 between two or more geographical features 764 rendered in the map image 760. In example embodiments, the relationship 778 may be selected based on a closest match to a relationship in a list of available relationships. The relationships in the list of available relationships may include those pertaining to relative orientation (such as parallel, perpendicular, 45 degrees, etc.), relative order (such as one association is to the left of another association, one association is above another association, one association is 45 degrees north-east of another association, from left to right, top to bottom, east to west, south to north, etc.), relative size (one city block is smaller than another city block, etc.), intersections (such as the first association intersects with the second association and the third association), continuations (such as when a street changes names), and/or other describable and distinguishable relationships. In example embodiments, the relationship 578 and the relationship 778 may be derived using similar or substantially the same relationships and/or lists of available relationships.

In the deriving (e.g., action 750) of a record set 770, example embodiments may also select (e.g., action 742) a classification 779 for the transformed representation 774, the textual representation 772, the geographical feature 764, and/or the geographical label 762 from among a list of available classifications. The list of classifications may include one or more man-made geographical features and/or one or more naturally-occurring geographical features, and may be the same list of classifications used in the selecting of a classification for the transformed representation 574 and/or the textual representation 572. For example, geographical features in the list of classifications may include a street (or type of street, such as an avenue, street, road, crescent, circle, highway, freeway, toll way, etc.), an intersection (such as a 3-way intersection, 4-way intersection, 5-way intersection, intersection between a street and a railway, etc.), bridge (such as a pedestrian bridge, vehicular bridge, etc.), tunnel, railway, pedestrian walkway, waterway (such as a stream, river, channel, etc.), landmark (such as a building, monument, business, park, etc.), and the like. In example embodiments, the classification 579 and the classification 779 may be derived using similar or substantially the same classifications and/or lists of available classifications.

Accordingly, each record set 770 for a map image 760 may comprise one or more geographical labels 762 rendered in the map image 760, one or more geographical features 764 rendered in the map image 760, one or more textual representations 772 of geographical labels 762 rendered in the map image 760, one or more transformed representations 774 of geographical features 764 rendered in the map image 760, one or more associations (or pairings) 776, one or more relationships 778, and/or one or more classifications 779.

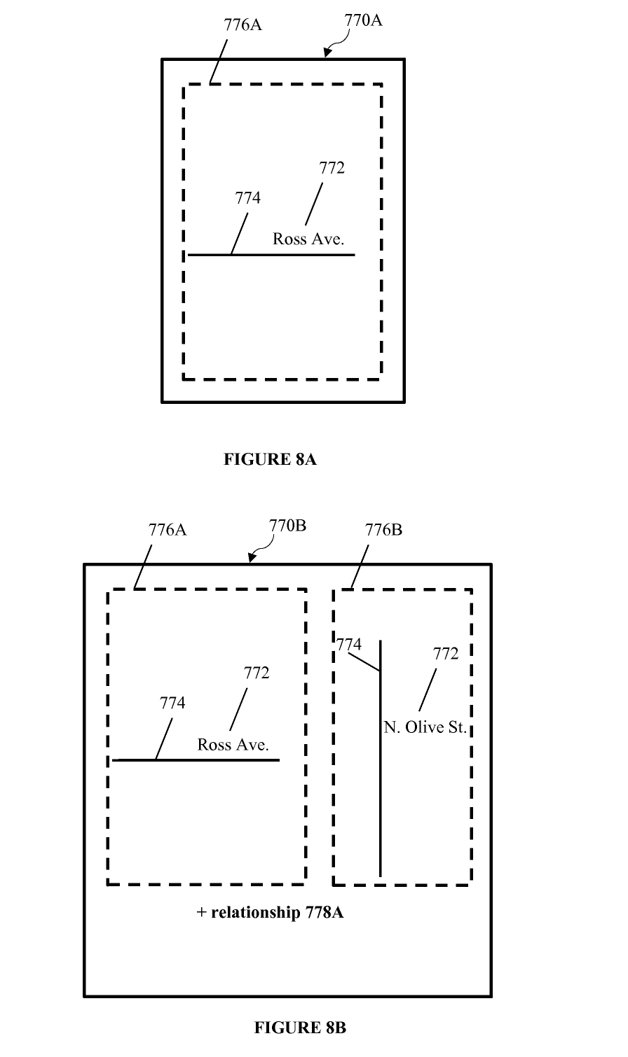

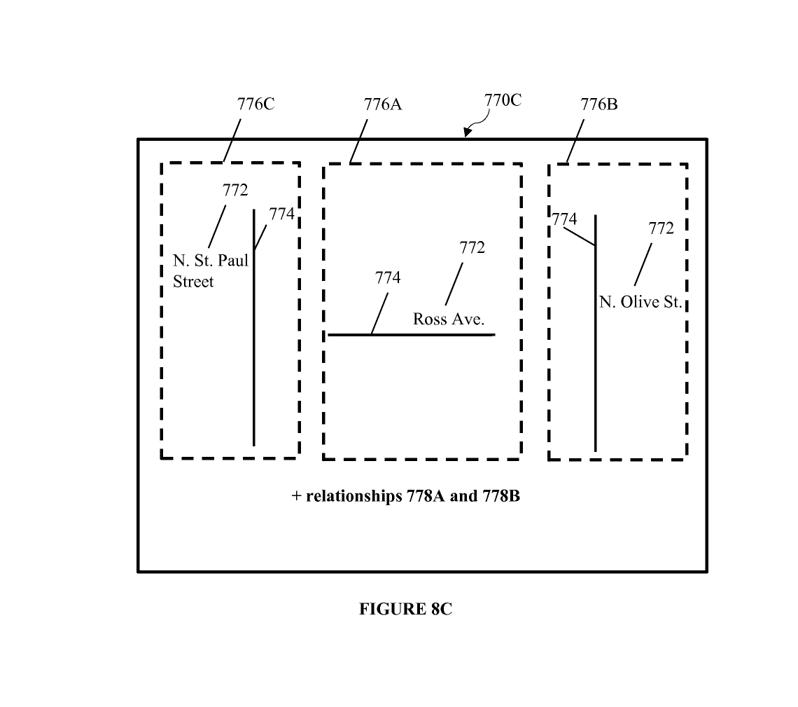

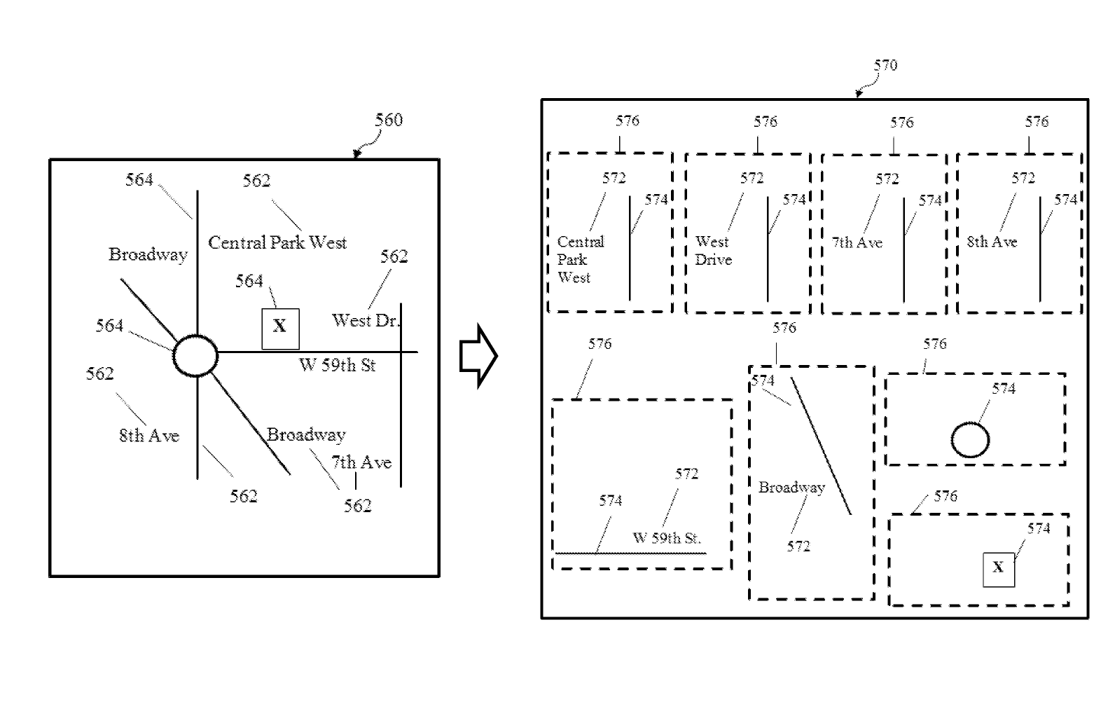

It is recognized in the present disclosure that a record set 770 comprising a greater number of associations 776, relationships 778, and/or classifications 779 may enable example embodiments to more quickly and/or accurately search for and return a resultant map. For example, as conceptually illustrated in FIG. 8A, a record set 770A having only one association 776A (a transformed representation of a street and its corresponding textual representation of “Ross Ave”) will likely be similar to or substantially the same as record sets for many other map images (for example, map images in many other cities around the world).

However, as conceptually illustrated in FIG. 8B, a record set 770B having a first association 776A (a first transformed representation of a first street and its corresponding first textual representation of “Ross Ave”), a second association 776B (a second transformed representation of a second street and its corresponding second textual representation of “Olive St”), and a relationship 778A between the first association/transformed representation and the second association/transformed representation (substantially perpendicular to each other) may be similar to or substantially the same as far fewer record sets (as compared to the example embodiment in FIG. 8A). As another example, as conceptually illustrated in FIG. 8C, a record set 770C having a first association 776A (a first transformed representation of a first street and its corresponding first textual representation of “Ross Ave”), a second association 776B (a second transformed representation of a second street and its corresponding second textual representation of “Olive St”), a third association 776C (a third transformed representation of a third street and its corresponding third textual representation of “St. Paul Street”), a first relationship 778A between the first association/transformed representation and the second association/transformed representation (substantially perpendicular to each other), a second relationship 778B between the first association/transformed representation and the third association/transformed representation (substantially perpendicular to each other), and a third relationship 778C between the second association/transformed representation and the third association/transformed representation (substantially parallel to each other) may be similar to or substantially the same as even fewer record sets (as compared to the example embodiments in FIGS. 8A and 8B).

### (iv) Search a Map Database (e.g., Action 340)

Example embodiments may be operable to perform a search (e.g., action 340) in the map database 220 for a resultant map using the revised search query set 570 of the input image 560.

In performing the search (e.g., action 340) of the map database 220, example embodiments may identify and select one or more candidate map images from among the one or more map images 760 in the map database 220. The one or more candidate map images may be selected based on one or more criterion. For example, example embodiments may select the one or more candidate map images based on a portion of the revised search query set 570. More specifically, the selection may be performed by first comparing the textual representation(s) 572 (and/or textual feature(s) 562) in the revised search query set 570 to the textual representation(s) 772 (and/or geographical label(s) 762) in the record set 770 of each selected map image 760. Alternatively or in addition, the selection may be performed by comparing the transformed representation(s) 574 (and/or the non-textual feature(s) 564) in the revised search query set 570 to the transformed representation(s) 774 (and/or geographical feature(s) 764) in the record set 770 of each selected map image 760. Alternatively or in addition, the selection may be performed by comparing the associations 576 for the input image 560 to the associations 776 of each selected map image 760. Alternatively or in addition, the selection may be performed by comparing the relationships 578 for the input image 560 to the relationships 778 of each selected map image 760. Alternatively or in addition, the selection may be performed by comparing the classifications 579 for the input image 560 to the classifications 779 of each selected map image 760. Example embodiments may also perform the selection using the user's previous history of map searches, the user's current location, the immediately preceding activity by the user on the computing device 201, other information gatherable by the user's computing device 201 and/or processor 210, and the like.

In performing the search (e.g., action 340) of the map database 220 for a resultant map image that is a closest match to the revised search query set, example embodiments may compare some, most, or all of the revised search query set 570 to some, most, or all of the record set 770 associated with each of the selected map images 760. Alternatively or in addition, example embodiments may compare some, most, or all of the revised search query set 570 to the geographical feature(s) 764, geographical label(s) 762, association(s) 776, relationship(s) 778, and/or classification(s) 779 in each of the selected map image 760.

### (v) Return a Resultant Map Image (e.g., Action 350)

Example embodiments may be operable to return (e.g., action 350) one or more resultant map images from among the one or more selected map images when the record set 770 (and/or the geographical feature(s) 764, geographical label(s) 762, association(s) 776, relationship(s) 778, and/or classification(s) 779) associated with the resultant map image is determined by the searching and comparing (e.g., action 340) to be a match to the revised search query set 570. The match may be based on one of a plurality of criterion. In an example embodiment, a selected map image may be determined to be the closest match (the resultant map image) when the selected map image comprises more matches of elements (geographical feature(s) 764, geographical label(s) 762, association(s) 776, relationship(s) 778, and/or classification(s) 779) of the record set 770 to the revised search query set 570. In another example embodiment, when two selected map images comprise the same number of matching geographical features 764 and geographical labels 762, preference (or confidence level) may be given to the selected map image that comprises a relationship 778 (and/or association 776 and/or classification 779) that is a closer match to a relationship 578 (and/or association 576 and/or classification 579) of the revised search query set 570. In another example embodiment, in a situation when a first selected map image comprises lesser (or the same) number of matching geographical feature(s) 764 and/or geographical label(s) 762 as compared to a second selected map image but only the first selected map image comprises a relationship 778 (such as “intersecting”) between two geographical features 764 that matches a relationship 578 (such as “intersecting”) between two non-textual features 564 (and the two geographical features 764 matches the two non-textual features 564), preference (or confidence level) may be given to the first selected map image. In another example embodiment, in a situation when a first selected map image comprises lesser (or the same) number of matching geographical feature(s) 764 and/or geographical label(s) 762 as compared to a second selected map image, the first selected map image comprises a classification “street” for a geographical feature 764 “Hudson”, the second selected map image comprises a classification “river” for a geographical feature 764 “Hudson”, and the revised search query 570 comprises a classification “street” for a non-textual feature 564 “Hudson”, preference (or confidence level) may be given to the first selected map image. In another example embodiment, in a situation when a first selected map image comprises lesser (or the same) number of matching geographical feature(s) 764 and/or geographical label(s) 762 as compared to a second selected map image, the first selected map image comprises an association between a first geographical feature 764 (such as a line) and a first geographical label 762 (such as “Columbus”), the second selected map image comprises an association between a second geographical feature 764 (such as a circle) and a second geographical label 762 (such as “Columbus”), and the revised search query set 570 comprises an association between a non-textual feature 564 (such as a circle) and a textual feature 562 (such as “Columbus”), preference (or confidence level) may be given to the first selected map image. Other variants and/or combinations of the aforementioned example embodiments for selecting a closest match (the resultant map image) from among more than one selected map images are contemplated in the present disclosure.

The resultant map image(s) may be returned in example embodiments as one or more map images from the map database 220, a portion of a larger map image from the map database 220, one or more map portions of one or more map images, one or more map tiles, and/or one or more links to view or download the resultant map image, and such map images may be pre-constructed and/or generated upon demand.

The resultant map image may comprise an indication of a location that is a match to the non-textual feature(s) 564 (and/or textual feature(s) 562) rendered in the input image 560, an overlay of the non-textual feature(s) 564 and/or textual feature(s) 562 on the resultant map image, one or more routes to the location matching the non-textual feature 564 rendered on the input image 560 (such as from the user's present location), and/or other information that is or may be useful to the user.

### Example of Performing a Search for a Map Using an Input Image as a Search Query

In an example situation, person A provides a meeting point location to person B by drawing an approximate map for person B on a piece of paper. Using an integrated camera of a mobile computing device 201, such as an Apple iPhone or a Samsung Galaxy device, person B may capture the map on the piece of paper and provide to processor 210 via network 230 the captured image as an input image 560, as illustrated in FIG. 9. Once received, processor 210 may be operable to derive a revised search query set 570 of the input image 560 by performing a character recognition process and an image recognition process to derive textual representations 572 of textual features 562 rendered in the input image 560 and transformed representations 574 of non-textual features 572 rendered in the input image, respectively. Example embodiments may also be operable to perform associations 576 of the textual representations 572 and its corresponding transformed representations 574. Example embodiments may also be operable to derive relationships (not shown) between transformed representations. For example, the relationship between the transformed representation corresponding to the textual representation “7th Ave” and the transformed representation corresponding to the textual representation “W 59th St” may be “perpendicular”. As another example, the relationship between the transformed representation corresponding to the textual representation “7th Ave” and the transformed representation corresponding to the textual representation “Broadway” may be “45 degrees”. As another example, the relationship between the transformed representation corresponding to the textual representation “7th Ave” and the transformed representation corresponding to the textual representation “West Dr” may be “continued”. As another example, the relationship between the transformed representation corresponding to the textual representation “Central Park West” and the transformed representation corresponding to the textual representation “7th Ave” may be “parallel”. As another example, the relationship between the transformed representation corresponding to the textual representation “7th Ave” and the transformed representation corresponding to the textual representation “Broadway” may be “non-intersecting”. Example embodiments may also be operable to derive classifications (not shown) for each association (or transformed representation or textual representation). For example, the classification for each of the textual representations and corresponding transformed representations of “7th Ave”, “W 59th St”, “Central Park West”, “West Dr.”, and “Broadway” may be “street”.

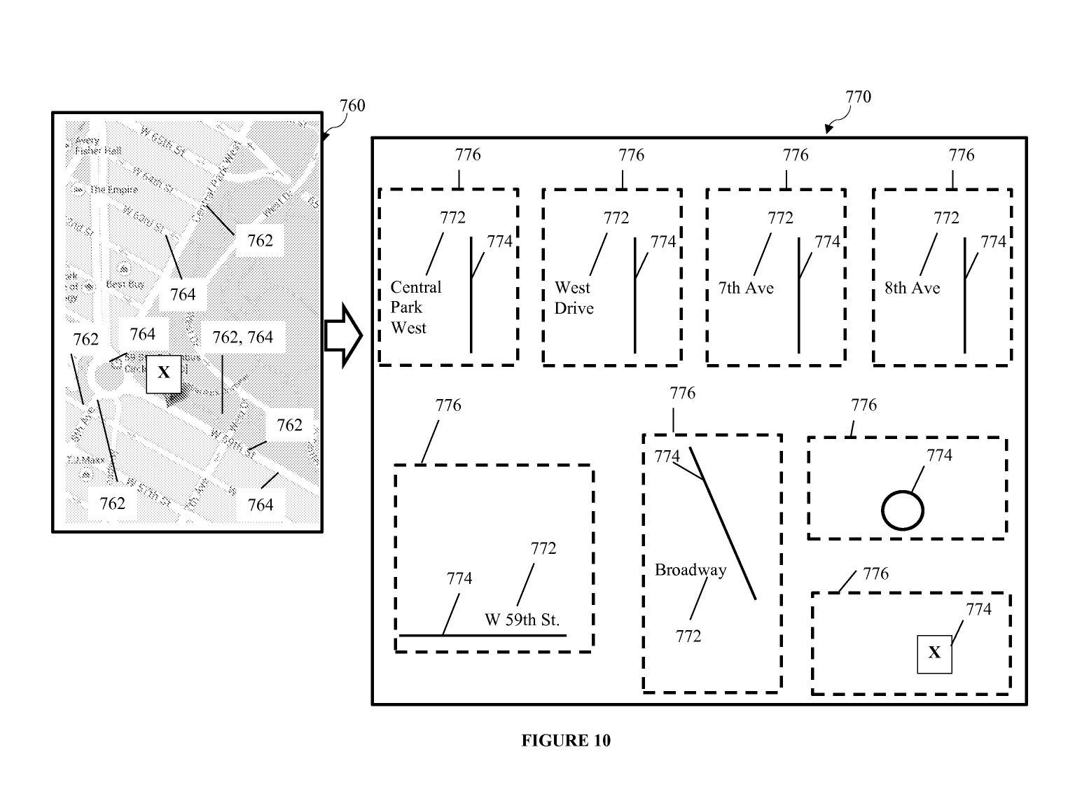

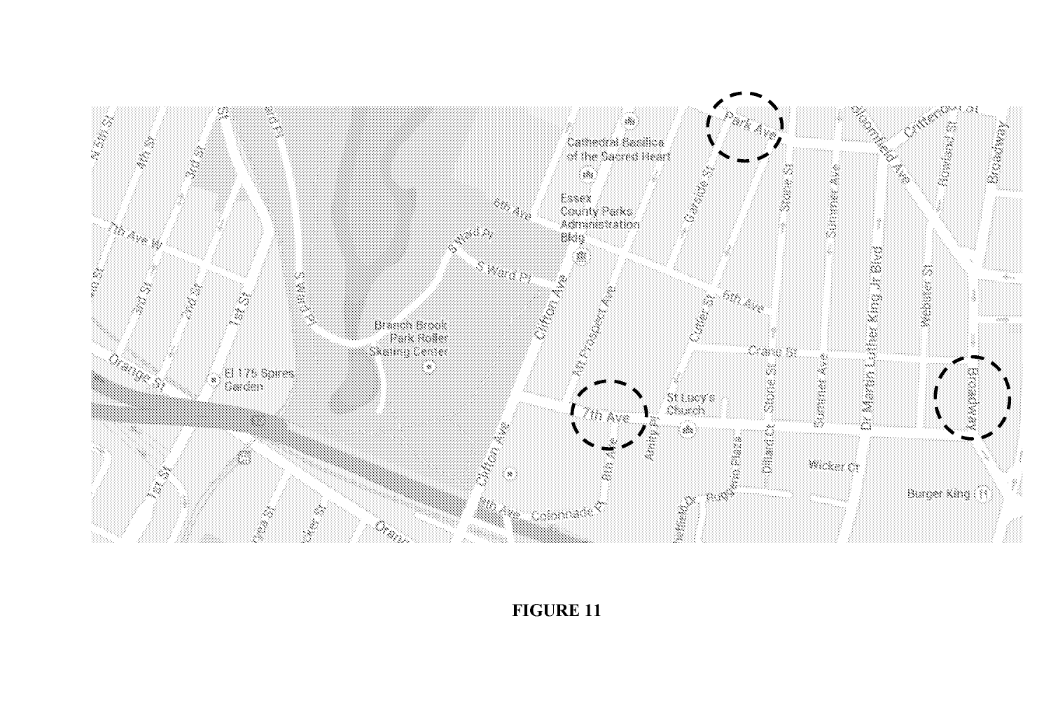

Once the revised search query 570 is received, processor 210 may be operable to perform a search of map database 220. In an example embodiment, the steps of preparing the map database 220 may be previously performed at some time before the search. In doing so, one or more record sets for one or more map images in the map database 220, such as record sets for the city of Manhattan, N.Y. and the city of Newark, N.J., may have been derived. For example, as illustrated in FIG. 10, a record set 770 for map image 760, which corresponds to a portion of the city of Manhattan, N.Y., may be derived having transformed representations 774 of geographical features 764 rendered in the map image 760 and textual representations 772 of geographical labels 762 in the map image 760. In this example, a record set may be derived comprising a textual representation of geographical feature “Broadway”, a textual representation of geographical feature “7th Ave”, a textual representation of geographical feature “Central Park West”, a relationship between the transformed representations corresponding to the geographical features “Broadway” and “7th Ave” as “non-intersecting”, and a relationship between the transformed representations corresponding to the geographical features “Broadway” and “7th Ave” as “45 degrees”. A record set for an map image corresponding to a portion of the city of Newark, NJ (illustrated in FIG. 11) may also be derived having a textual representation of a geographical feature “Broadway” (circled in FIG. 11), a textual representation of a geographical feature “7th Ave” (circled in FIG. 11), a textual representation of a geographical feature “Park Ave”, a relationship between the transformed representations corresponding to the geographical features “Broadway” and “7th Ave” as “intersecting”, and a relationship between the transformed representations corresponding to the geographical features “Broadway” and “7th Ave” as “30 degrees”. Upon performing the search, example embodiments may be operable to compare the revised search query set 570 with one or more record sets, including the record set 770 of the portion of the city of Manhattan (as illustrated in FIG. 10) and the record set of the portion of the city of Newark (as illustrated in FIG. 11). Based on the search and comparison, the record set 770 of the portion of the city of Manhattan (as illustrated in FIG. 10) may be determined to be a closest match to the revised search query set 570 since, for example, the relationship between “Broadway” and “7th Ave” being “non-intersecting” in the revised search query will more match (closer match to) the record set 770 of the portion of the city of Manhattan (as illustrated in FIG. 10) than the record set of the portion of the city of Newark (as illustrated in FIG. 11).

Accordingly, the map image 760 of the portion of the city of Manhattan (as illustrated in FIG. 10) may be returned as a resultant map image for the image search. It is to be understood in the present disclosure that other resultant map image(s) may also be returned if the revised search query set 570 is found to be a closest match to more than one resultant map image. In example embodiments, the one or more resultant map images may be returned as one or more map images, a plurality of map tiles, or the like, assembled together at the computing device 201, processor 210, and/or map database 220, and/or link(s) to a resultant map image. In example embodiments, the one or more resultant map images may also comprise directions, routes, alternative views (such as satellite views, street views, etc.), and other information overlays. For example, the resultant map image may comprise directions from the location of the computing device 201 and/or other starting points.

While various embodiments in accordance with the disclosed principles have been described above, it should be understood that they have been presented by way of example only, and are not limiting. Thus, the breadth and scope of the example embodiments described herein should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, as referred to herein, a computing device, communication device, or capturing device may be a virtual machine, computer, node, instance, host, or machine in a networked computing environment. Also as referred to herein, a network or cloud may be a collection of machines connected by communication channels that facilitate communications between machines and allow for machines to share resources. Network may also refer to a communication medium between processes on the same machine. Also as referred to herein, a network element, node, or server may be a machine deployed to execute a program operating as a socket listener and may include software instances.

Resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof.

A network or cloud may include, but is not limited to, computing grid systems, distributed computing environments, cloud computing environment, etc. Such network or cloud includes hardware and software infrastructures configured to form a virtual organization comprised of multiple resources which may be in geographically disperse locations.

Although various computer elements, communication devices and capturing devices have been illustrated herein as single device or machine, such elements may operate over several different physical machines, or they may be combined as operating code instances running on a single physical machine. The claims in the present application comprehend such variation in physical machine configurations.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result. Words relating to relative position of elements such as “about,” “near,” “proximate to,” and “adjacent to” shall mean sufficiently close to have a material effect upon the respective system element interactions.

Additionally, the section headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A method of searching for a map, the method comprising:
receiving, as a search query, an input image depicting a map;
performing an image recognition process to the map depicted in the input image, the image recognition process operable to:
locate a non-textual feature rendered in the map depicted in the input image, and
derive a transformed representation of the non-textual feature rendered in the map depicted in the input image;
performing a character recognition process to the map depicted in the input image, the character recognition process operable to:
locate a textual feature rendered in the map depicted in the input image, and
derive a textual representation of the textual feature rendered in the map depicted in the input image;
performing a search query revision process to generate a revised search query set, the revised search query set comprising the transformed representation of the non-textual feature rendered in the map depicted in the input image and the textual representation of the textual feature rendered in the map depicted in the input image;
searching, in a map database, the searching comprising comparing the revised search query set to a record set associated with one or more map images in the map database, each record set of each map image in the map database comprising a transformed representation of a geographical feature rendered in the map image and a textual representation of a geographical label in the map image; and
returning a resultant map image from among the one or more map images used in the comparing when the record set associated with the resultant map image is determined by the comparing to be a match to the revised search query set, wherein the resultant map image includes an indication of a location on the resultant map image that is a match to the non-textual feature rendered in the map depicted in the input image.

2. (canceled)

3. The method of claim 1, wherein:
the revised search query set further comprises a first association, the first association being an association between the textual representation of the textual feature rendered in the input image and the transformed representation of the non-textual feature rendered in the input image;
the record set further comprises a second association, the second association being an association between the textual representation of the geographical label and the transformed representation of the geographical feature; and
the comparing further comprises comparing the first association to the second association.

4. The method of claim 1, wherein:
the revised search query set further comprises a first relationship, the first relationship being a relationship between the transformed representation of the non-textual feature rendered in the input image and a transformed representation of a second non-textual feature rendered in the input image;
the record set further comprises a second relationship, the second relationship being a relationship between the transformed representation of the geographical feature and a transformed representation of a second geographical feature rendered in the map image; and
the comparing further comprises comparing the first relationship to the second relationship.

5-6. (canceled)

7. The method of claim 1, wherein:
the revised search query set further comprises a first classification, the first classification being a classification for the transformed representation of the non-textual feature rendered in the input image and/or the textual representation of the textual feature rendered in the input image selected from among a first list of classifications;
the record set further comprises a second classification, the second classification being a classification for the transformed representation of the geographical feature rendered in the map image and/or the textual representation of the geographical label in the map image selected from among a second list of classifications; and
the comparing further comprises comparing the first classification to the second classification.

8. (canceled)

9. The method of claim 1, wherein:
the character recognition process is further operable to locate one or more other textual features rendered in the input image and derive a textual representation for each of the one or more other textual features rendered in the input image;
the image recognition process is further operable to locate one or more other non-textual features rendered in the input image and derive a transformed representation for each of the one or more other non-textual features rendered in the input image; and
the revised search query set further comprises the textual representations of the one or more other textual features rendered in the input image and the transformed representations of the one or more other non-textual features rendered in the input image.

10. The method of claim 9, wherein:
the record set further comprises transformed representations of one or more other geographical features rendered in the map image and textual representations of one or more other geographical labels in the map image;
the comparing further comprises comparing the textual representations of the one or more other textual features rendered in the input image to the textual representations of the one or more other geographical labels; and
the comparing further comprises comparing the transformed representations of the one or more other non-textual features rendered in the input image to the transformed representations of the one or more other geographical features rendered in the map image.

11. The method of claim 1, wherein:
the deriving of the transformed representation of the non-textual feature rendered in the input image includes applying a simplifying or normalizing procedure to the non-textual feature rendered in the input image; and
the transformed representation of the geographical feature rendered in the map image is obtained by applying the simplifying or normalizing procedure to the geographical feature rendered in the map image.

12. The method of claim 1, wherein:
the transformed representation of the non-textual feature rendered in the input image comprises one or more geometric shapes selected from among a first list of available geometric shapes; and
the transformed representation of the geographical feature rendered in the map image comprises one or more geometric shapes selected from among a second list of available geometric shapes.

13-15. (canceled)

16. A method of searching for a map, the method comprising:
receiving, as a search query, an input image depicting a map;
deriving a transformed representation of a non-textual feature rendered in the map depicted in the input image, wherein the transformed representation of the non-textual feature rendered in the map depicted in the input image is an image derived based on the non-textual feature rendered in the map depicted in the input image;
deriving a textual representation of a textual feature rendered in the map depicted in the input image;
generating a revised search query, the revised search query comprising the transformed representation of the non-textual feature rendered in the map depicted in the input image and the textual representation of the textual feature rendered in the map depicted in the input image;
searching, in a map database, the searching comprising comparing the revised search query to a non-textual feature and textual feature rendered in one or more map images in the map database; and
returning a resultant map image when the resultant map image is determined by the comparing to be a match to the revised search query.

17. (canceled)

18. The method of claim 16, wherein:
the revised search query further comprises a first association, the first association being an association between the textual representation of the textual feature rendered in the input image and the transformed representation of the non-textual feature rendered in the input image; and
the comparing further comprises comparing the first association to a second association, the second association being an association between the non-textual feature and the textual feature rendered in the one or more map images.

19. The method of claim 16, wherein:
the revised search query further comprises a first relationship, the first relationship being a relationship between the transformed representation of the non-textual feature rendered in the input image and a transformed representation of a second non-textual feature rendered in the input image; and
the comparing further comprises comparing the first relationship to a second relationship, the second relationship being a relationship between the non-textual feature rendered in the map image and a second non-textual feature rendered in the map image.

20-23. (canceled)

24. The method of claim 16,
further comprising deriving a textual representation for one or more other textual features rendered in the input image; and
further comprising deriving a transformed representation for one or more other non-textual features rendered in the input image;
wherein the revised search query further comprises the textual representations of the one or more other textual features rendered in the input image and the transformed representations of the one or more other non-textual features rendered in the input image.

25. The method of claim 24, wherein:
the comparing further comprises comparing the textual representations of the one or more other textual features rendered in the input image to one or more other non-textual features in the map image; and
the comparing further comprises comparing the transformed representations of the one or more other non-textual features rendered in the input image to one or more other non-textual features rendered in the map image.

26-42. (canceled)

43. A method of configuring a system to perform a search for a map using an input image as a search query, the system comprising a map database and a processor, the method comprising:
configuring the map database, the configuring comprising:
locating a geographical feature rendered in a map image of the map database;
deriving a transformed representation of the geographical feature;
locating a geographical label in the map image associated with the geographical feature; and
creating a record set associated with the map image, the record set comprising the geographical label and the transformed representation of the geographical feature; and
configuring the processor, the processor in communication with the map database, the processor configured to:
receive, as a search query, an input image depicting a map;
locate a non-textual feature rendered in the map depicted in the input image;
derive a transformed representation of the non-textual feature rendered in the map depicted in the input image;
locate a textual feature rendered in the map depicted in the input image;
derive a textual representation of the textual feature rendered in the map depicted in the input image;
create a revised search query set, the revised search query set comprising the textual representation of the textual feature rendered in the map depicted in the input image and the transformed representation of the non-textual feature rendered in the map depicted in the input image;
search the map database, the search comprising comparing the revised search query set to the record set and record sets associated with other map images in the map database; and
return a resultant map image from among the map image and the other map images when the record set associated with the resultant map image is determined by the search to be a match to the revised search query set, wherein the processor is configurable to include, in the resultant map image, an indication of a location on the resultant map image that is a match to the non-textual feature rendered in the map depicted in the input image.

44-49. (canceled)

50. The method of claim 1, wherein the map depicted in the input image comprises a user-drawn map.

51. The method of claim 1, wherein the map depicted in the input image comprises a computer-assisted drawing of a map.

52. The method of claim 1, wherein the map depicted in the input image comprises a screen capture of a map rendered by a map application or online map service.

53. The method of claim 1, further comprising enabling a user to draw the map depicted in the input image.

54. The method of claim 16, wherein the map depicted in the input image comprises a user-drawn map.

55. The method of claim 16, wherein the map depicted in the input image comprises a computer-assisted drawing of a map.

56. The method of claim 16, wherein the map depicted in the input image comprises a screen capture of a map rendered by a map application or online map service.

57. The method of claim 16, further comprising enabling a user to draw the map depicted in the input image.

58. The method of claim 43, wherein the processor is further configurable to enable a user to draw the map depicted in the input image.
